(19) United States
(12) Patent Application Publication
(10) Pub. No.: US 2025/0085455 A1
(43) Pub. Date: Mar. 13, 2025

(54) FACIES CLUSTERING FOR SUBTERRANEAN PROPERTY MODELING AND WELL PLACEMENT

(71) Applicant: Saudi Arabian Oil Company, Dhahran (SA)

(72) Inventors: Mohammed Al Madani, Dhahran (SA); Marei Al Garni, Dhahran (SA); Maan Al Hawi, Dammam (SA)

(21) Appl. No.: 18/463,011

(22) Filed: Sep. 7, 2023

(51) Int. Cl. G01V 99/00

(52) U.S. Cl. CPC G01V 20/00

(57) ABSTRACT

The present disclosure relates to methods and apparatuses for determining subterranean properties of a reservoir. An example method includes receiving log data for a plurality of wells in the reservoir, the log data representing at least one petrophysical property of a subsurface of the reservoir for the plurality of wells, generating multiple facies clusters based on the log data, determining one or more neighbor wells for each of the plurality of wells based on geographic locations of the plurality of wells, and for each of the plurality of wells, determining that the well is within a threshold distance of a facies cluster boundary upon determining that the well and a neighbor well of the well are represented by different facies clusters.

### TECHNICAL FIELD

The present disclosure generally relates to determining subterranean properties of a reservoir.

### BACKGROUND

In geology, sedimentary facies are bodies of sediment that are recognizably distinct from adjacent sediments that resulted from different depositional environments. Generally, geologists distinguish facies by aspects of the rock or sediment being studied. Seismic facies are groups of seismic reflections whose parameters (such as amplitude, continuity, reflection geometry, and frequency) differ from those of adjacent groups. Seismic facies analysis, a subdivision of seismic stratigraphy, plays an important role in hydrocarbon exploration and is one key step in the interpretation of seismic data for reservoir characterization. The seismic facies in a given geological area can provide useful information, particularly about the types of sedimentary deposits and the anticipated lithology.

In reflection seismology, geologists and geophysicists perform seismic surveys to map and interpret sedimentary facies and other geologic features for applications, for example, identification of potential petroleum reservoirs. Seismic surveys are conducted by using a controlled seismic source (for example, a seismic vibrator or dynamite) to create seismic waves. The seismic source is typically located at ground surface. Seismic body waves travel into the ground, are reflected by subsurface formations, and return to the surface where they recorded by sensors called geophones. Seismic surface waves travel along the ground surface and diminish as they get further from the surface. Seismic surface waves travel more slowly than seismic body waves. The geologists and geophysicists analyze the time it takes for the seismic body waves to reflect off subsurface formations and return to the surface to map sedimentary facies and other geologic features. Similarly, analysis of the time it takes seismic surface waves to travel from source to sensor can provide information about near surface features. This analysis can also incorporate data from sources, for example, borehole logging (also known as well logging), gravity surveys, and magnetic surveys.

### SUMMARY

The technology described in this disclosure relates to determining subterranean properties of a reservoir via facies clustering. One objective of reservoir characterization is to predict facies propagation across reservoirs or any other subsurface layer. During well drilling, from a surface to a targeted layer, petrophysical logs record signatures of penetrated rocks which permit to determine formation tops and characteristics of rocks. Thus, the petrophysical logs may help define depositional elements such as channel, levee and floodplains deposits.

In an aspect, a method for determining subterranean properties of a reservoir includes receiving log data for a plurality of wells in the reservoir. The log data represents at least one petrophysical property of a subsurface of the reservoir for the plurality of wells. The method further includes generating multiple facies clusters based on the log data. Each facies cluster represents a set of wells of the plurality of wells that are associated with similar values for the at least one petrophysical property of the subsurface. The method further includes determining one or more neighbor wells for each of the plurality of wells based on geographic locations of the plurality of wells. The one or more neighbor wells are selected from the plurality of wells. The method further includes, for each of the plurality of wells, determining that the well is within a threshold distance of a facies cluster boundary upon determining that the well and a neighbor well of the well are represented by different facies clusters. The method further includes, for each well with the threshold distance of the facies cluster boundary, determining a similarity score between the well and each facies cluster and updating the facies cluster representing the well. The similarity score represents a similarity between the at least one petrophysical property for the well and the at least one petrophysical property for the set of wells represented by each facies cluster. The updated facies cluster has the largest similarity score with the well among the multiple facies clusters. The method further includes determining the subterranean properties of the reservoir based on the multiple facies clusters and the set of wells represented by each facies cluster.

In some implementations, the method further includes identifying a target layer representing a presence of hydrocarbons based on the determined subterranean properties of the reservoir and drilling a well to the target layer.

In some implementations, the method further includes selecting a new geographic location in the reservoir for drilling a new well, receiving log data for the new well, and assigning one of the multiple facies clusters to the new well based on the new geographic location and the log data of the new well.

In some implementations, the plurality of wells in the reservoir is determined by removing outliers from an initial set of wells in the reservoir.

In some implementations, the multiple facies clusters are generated by applying a standard k-mean clustering algorithm to the log data for the plurality of wells.

In some implementations, the method further includes identifying a key well for each of the multiple facies clusters.

In some implementations, the at least one petrophysical property comprises a gamma ray (GR) signature, and for each of the multiple facies clusters, the key well for the facies cluster has the GR signature closest to an average of the GR signature of the set of wells represented by the facies cluster.

In some implementations, for each of the multiple facies clusters, the key well for the facies cluster is determined by one or more geologists based on core data analysis.

In some implementations, for each of the multiple facies clusters, the set of wells represented by the facies cluster are determined based on distances of the set of wells with respect to the key well.

In some implementations, for each of the plurality of wells, the one or more neighbor wells of the well are determined by a Triangulation algorithm based on the geographic locations of the plurality of wells such that the well is a centroid of a polygon with respect to the one or more neighbor wells.

In some implementations, the assigning one of the multiple facies clusters to the new well includes training and validating a supervised artificial intelligence (AI) model using the geographic locations of the plurality of wells and the multiple facies clusters and determining a facies cluster for the new well using the supervised AI model based on the geographic location of the new well and the log data of the new well.

In some implementations, the supervised AI model is an artificial neural network.

In another aspect, a system for determining subterranean properties of a reservoir includes one or more processing devices and one or more non-transitory machine-readable storage devices storing programming instructions for execution by the one or more processing devices to cause the system to perform operations. The operations include receiving log data for a plurality of wells in the reservoir, the log data representing at least one petrophysical property of a subsurface of the reservoir for the plurality of wells. The operations further include generating multiple facies clusters based on the log data, each facies cluster representing a set of wells of the plurality of wells that are associated with similar values for the at least one petrophysical property of the subsurface. The operations further include determining one or more neighbor wells for each of the plurality of wells based on geographic locations of the plurality of wells. The one or more neighbor wells are selected from the plurality of wells. The operations further include for each of the plurality of wells, determining that the well is on a facies cluster boundary upon determining that the well and a neighbor well of the well are represented by different facies clusters. The operations further include for each well on the facies cluster boundary, determining a similarity score between the well and each facies cluster and updating the facies cluster representing the well. The similarity score represents a similarity between the at least one petrophysical property for the well and the at least one petrophysical property for the set of wells represented by each facies cluster. the updated facies cluster has the largest similarity score with the well among the multiple facies clusters. The operations further include determining the subterranean properties of the reservoir based on the multiple facies clusters and the set of wells represented by each facies cluster.

In some implementations, the multiple facies clusters are generated by applying a standard k-mean clustering algorithm to the log data for the plurality of wells.

In some implementations, the operations further include identifying a key well for each of the multiple facies clusters.

In some implementations, the at least one petrophysical property comprises a GR signature, and for each of the multiple facies clusters, the key well for the facies cluster has the GR signature closest to an average of the GR signature of the set of wells represented by the facies cluster.

In some implementations, the operations further include training and validating a supervised AI model using the geographic locations of the plurality of wells and the multiple facies clusters and determining a facies cluster for a new well using the supervised AI model based on a geographic location of the new well and the log data of the new well.

In another aspect, a non-transitory machine-readable storage device stores programming instructions for determining subterranean properties of a reservoir. The programming instructions are for execution by at least one processing device to cause performance of operations. The operations include receiving log data for a plurality of wells in the reservoir, the log data representing at least one petrophysical property of a subsurface of the reservoir for the plurality of wells. The operations further include generating multiple facies clusters based on the log data, each facies cluster representing a set of wells of the plurality of wells that are associated with similar values for the at least one petrophysical property of the subsurface. The operations further include determining one or more neighbor wells for each of the plurality of wells based on geographic locations of the plurality of wells. The one or more neighbor wells are selected from the plurality of wells. The operations further include for each of the plurality of wells, determining that the well is on a facies cluster boundary upon determining that the well and a neighbor well of the well are represented by different facies clusters. The operations further include for each well on the facies cluster boundary, determining a similarity score between the well and each facies cluster and updating the facies cluster representing the well. The similarity score represents a similarity between the at least one petrophysical property for the well and the at least one petrophysical property for the set of wells represented by each facies cluster. the updated facies cluster has the largest similarity score with the well among the multiple facies clusters. The operations further include determining the subterranean properties of the reservoir based on the multiple facies clusters and the set of wells represented by each facies cluster.

In some implementations, the multiple facies clusters are generated by applying a standard k-mean clustering algorithm to the log data for the plurality of wells.

In some implementations, the operations further include training and validating a supervised AI model using the geographic locations of the plurality of wells and the multiple facies clusters and determining a facies cluster for a new well using the supervised AI model based on a geographic location of the new well and the log data of the new well.

The details of one or more embodiments of these systems and methods are set forth in the accompanying drawings and the description to be presented. Other features, objects, and advantages of these systems and methods will be apparent from the description and drawings, and from the claims.

### BRIEF DESCRIPTION OF THE DRAWINGS

FIG. 1 illustrates an example of a subsurface.

FIG. 2A is a flow diagram that illustrates an example of a process.

FIG. 2B is a flow diagram that illustrates another example of a process.

FIGS. 3A-3C each include a graph that illustrates an example anomaly detection method.

FIG. 4 includes a graph that illustrates example labeled facies clusters.

FIG. 5 includes a graph that illustrates neighbor wells for the facies clusters of FIG. 4.

FIG. 6A includes a graph showing that silhouette score is used to underline the association of wells to multiple facies clusters.

FIG. 6B includes a graph showing updated facies clusters based on the silhouette score.

FIG. 6C includes a graph showing updated facies clusters based on a relaxation of the silhouette score.

FIGS. 7A-7C include example well log patterns in each facies cluster.

FIG. 8 is a block diagram illustrating an example computer system used to provide computational functionalities associated with described algorithms, methods, functions, processes, flows, and procedures as described in the present disclosure, according to some implementations of the present disclosure.

Like reference symbols in the various drawings indicate like elements.

### DETAILED DESCRIPTION

This specification describes determining subterranean properties of a reservoir via facies clustering. One objective of reservoir characterization is to predict facies propagation across reservoirs or any other subsurface layer. During well drilling, from a surface to a targeted layer, petrophysical logs record signatures of penetrated rocks which permit to determine formation tops and characteristics of rocks. Thus, the petrophysical logs may help define depositional elements such as channel, levee and floodplains deposits. Core data may give important information for geologists to build their conceptual model. In some implementations, core data may only be acquired in the reservoir section due to cost of this practice. As a result, geologists face numerous challenges, especially in the absence of core data, when classifying and identifying rock types within the same subsurface layer. These challenges might be the result of the lateral changes in rock characteristics or noise caused by mechanical factors that occur while drilling. In addition to that, discrepancy in interpretation could cause uncertainty in facies modeling. The drilling process may discover homogeneous layers that have the same rock type, and other layers that have heterogeneity in rock characteristics across the same layer. For accurate interpretations, it is desirable to map these different rock types and understand their propagation.

In view of the forgoing, the described process includes a hybrid approach of supervised and unsupervised learning to assign the penetrated rock to its proper facies package. Specifically, this process may detect anomalies, cluster data, and predict rock types in both historical and new wells. The described process may identify different rock types of a layer by preserve both the spatial relationship and the signature of each facies with similarity measures scoring at the same time. Each new well may provide more data which can be used to update the subsurface model. The process may use sequential processes to draw the facies propagation. When reaching a sample where log data give different signatures, the process may calculate similarity scores to check the values of this data and to include it in an appropriate rock type. The described process may improve accuracy of the subterranean property modelling by preserving the signature given by the well logs, the spatial relationship between wells, and similarity scores. It includes an enhanced preprocessing phase, which in turn is used in a deep learning training phase to produce a reliable Artificial Intelligence (AI) model. The process described herein interprets the hidden patterns discovered to maximize hydrocarbon recovery and to cluster rock types accurately. The technique successfully and accurately predicts rock types.

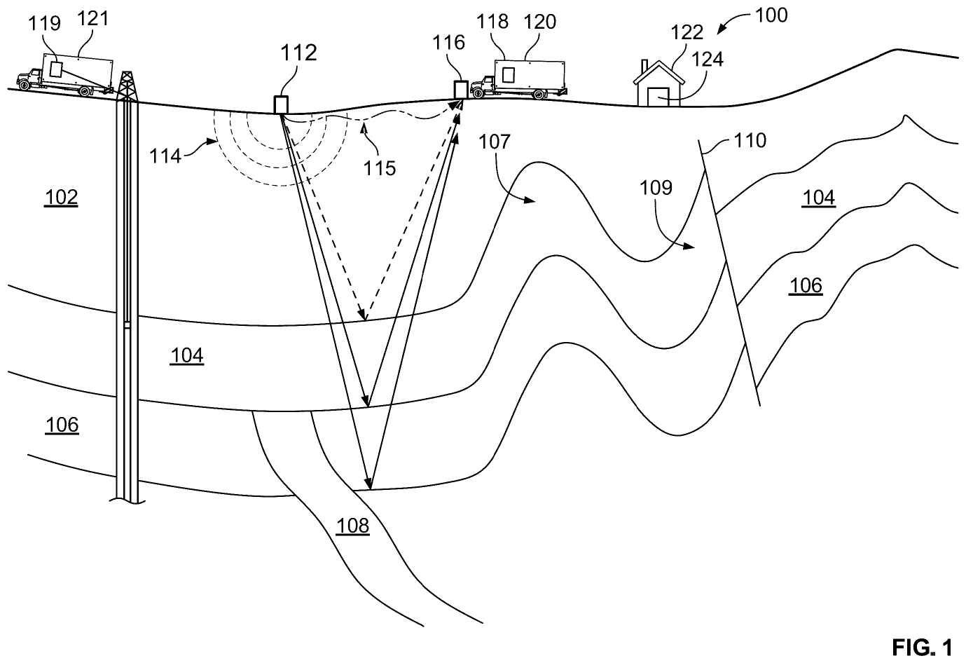

FIG. 1 is a schematic view of a seismic survey being performed to map subterranean features such as facies and faults in a subterranean formation 100. The technology described in this disclosure may use well log data to provide reliable and robust propagation of facies clusters across each subsurface layer, which can be used to better perform seismic survey. The subterranean formation 100 includes a layer of impermeable cap rock 102 at the surface. Facies underlying the impermeable cap rocks 102 include a sandstone layer 104, a limestone layer 106, and a sand layer 108. A fault line 110 extends across the sandstone layer 104 and the limestone layer 106.

Oil and gas tend to rise through permeable reservoir rock until further upward migration is blocked, for example, by the layer of impermeable cap rock 102. Seismic surveys attempt to identify locations where interaction between layers of the subterranean formation 100 are likely to trap oil and gas by limiting this upward migration. For example, FIG. 1 shows an anticline trap 107, where the layer of impermeable cap rock 102 has an upward convex configuration, and a fault trap 109, where the fault line 110 might allow oil and gas to flow in with clay material between the walls traps the petroleum. Other traps include salt domes and stratigraphic traps.

A seismic source 112 (for example, a seismic vibrator or an explosion) generates seismic waves that propagate in the earth. Although illustrated as a single component in FIG. 1, the source or sources 112 are typically a line or an array of sources 112. The generated seismic waves include seismic body waves 114 that travel into the ground and seismic surface waves 115 travel along the ground surface and diminish as they get further from the surface.

The velocity of these seismic waves depends properties, for example, density, porosity, and fluid content of the medium through which the seismic waves are traveling. Different geologic bodies or layers in the earth are distinguishable because the layers have different properties and, thus, different characteristic seismic velocities. For example, in the subterranean formation 100, the velocity of seismic waves traveling through the subterranean formation 100 will be different in the sandstone layer 104, the limestone layer 106, and the sand layer 108. As the seismic body waves 114 contact interfaces between geologic bodies or layers that have different velocities, each interface reflects some of the energy of the seismic wave and refracts some of the energy of the seismic wave. Such interfaces are sometimes referred to as horizons.

The seismic body waves 114 are received by a sensor or sensors 116. Although illustrated as a single component in FIG. 1, the sensor or sensors 116 are typically a line or an array of sensors 116 that generate an output signal in response to received seismic waves including waves reflected by the horizons in the subterranean formation 100. The sensors 116 can be geophone-receivers that produce electrical output signals transmitted as input data, for example, to a computer 118 on a seismic control truck 120. Based on the input data, the computer 118 may generate a seismic data output, for example, a seismic two-way response time plot.

The seismic surface waves 115 travel more slowly than seismic body waves 114. Analysis of the time it takes seismic surface waves 115 to travel from source to sensor can provide information about near surface features.

A control center 122 can be operatively coupled to the seismic control truck 120 and other data acquisition and wellsite systems. The control center 122 may have computer facilities for receiving, storing, processing, and analyzing data from the seismic control truck 120 and other data acquisition and wellsite systems that provide additional information about the subterranean formation. For example, the control center 122 can receive data from a computer 119 associated with a well logging unit 121. For example, computer systems 124 in the control center 122 can be configured to analyze, model, control, optimize, or perform management tasks of field operations associated with development and production of resources such as oil and gas from the subterranean formation 100. Alternatively, the computer systems 124 can be located in a different location than the control center 122. Some computer systems are provided with functionality for manipulating and analyzing the data, such as performing seismic interpretation or borehole resistivity image log interpretation to identify geological surfaces in the subterranean formation or performing simulation, planning, and optimization of production operations of the wellsite systems.

In some embodiments, results generated by the computer systems 124 may be displayed for user viewing using local or remote monitors or other display units. One approach to analyzing seismic data is to associate the data with portions of a seismic cube representing represent the subterranean formation 100. The seismic cube can also be display results of the analysis of the seismic data associated with the seismic survey.

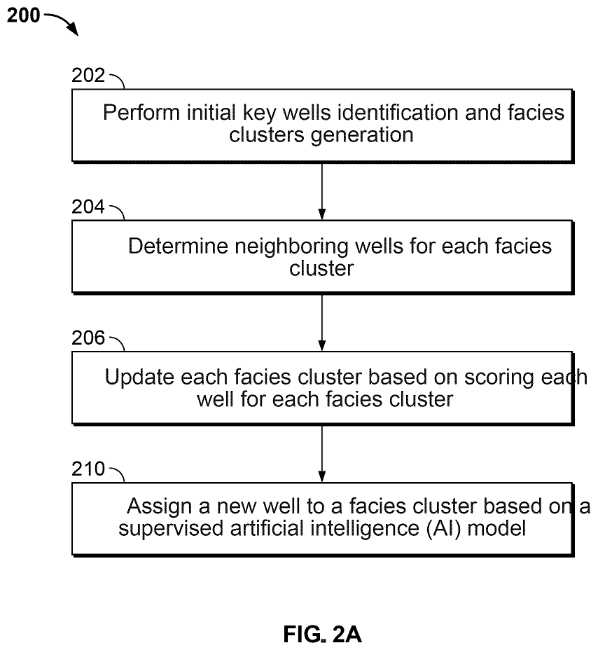

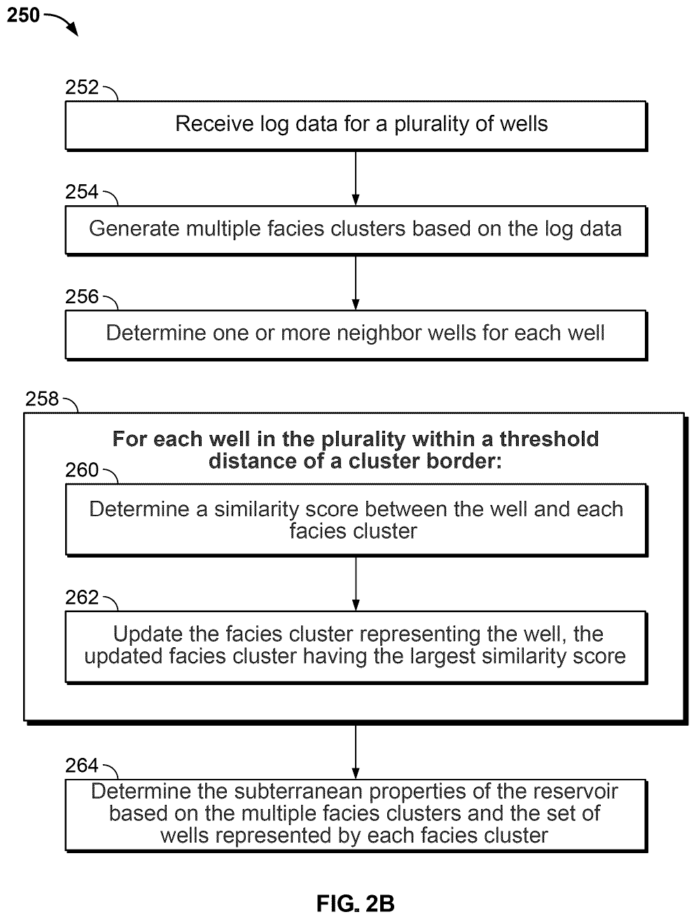

FIG. 2A illustrates an example workflow 200 for determining subterranean properties of a reservoir. Each of the workflows described in this document, including workflow 200 of FIG. 2A, can be implemented or executed using the computer system 124 as well as the workbench, computing device, and/or machine-learning engine described in this document. Descriptions of the different workflows in this document may reference the computer system 124, including other computational resources associated with computer system 124 as described in this document. In general, references to “the system(s)” corresponds to the computer system 124.

In some implementations, steps or actions of the different workflows are enabled by programmed firmware or software instructions, which are executable by one or more processors of the devices and resources described in this document. An example workflow may be referred to alternatively as a process or method of performing a particular set of tasks for determining subterranean properties of a reservoir.

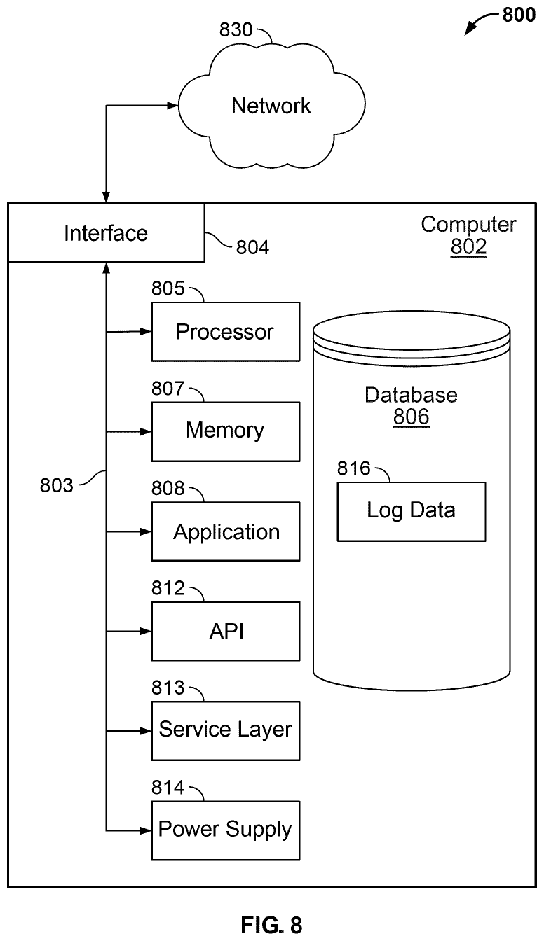

Process 200 includes performing (202), by a computing system such as the computing system subsequently described in relation to FIG. 8, initial key wells identification and facies cluster generation. The initial key wells identification and facies clusters generation may have 3 main approaches.

The first approach is the machine learning approach which is based on the standard k-mean and the usage of the silhouette score as a stopping criterion for the number of clusters. The outcome in this case are facies clusters. Following application of machine learning, the data processing system identifies the best representative well and call it a key well. The data processing system identifies a key well by computing the average GR signature of each cluster and comparing it with each sample in the same facies cluster. The sample that yields the minimum value will be identified as the key well.

The second approach is an interactive approach in which the data processing system receives input data, such as through a user interface, specifying the key wells. The data processing system can perform subsequent processing independent from execution of the machine learning model to identify the best key wells of each subsurface layer. The data processing system may already have enough core data such that a user is able to select the key wells (e.g., in response to presentation of the core data). The data processing system may be configured to display the core data to the user. The user may be one or more experts that are capable of performing core data analysis. For example, the user may be one or more geologists. The data processing system may receive a core data analysis result from the user. The core data analysis result includes the key wells identified by the user based on the user's knowledge and experiences. The data processing system performs clustering based on, for example, a Euclidean distance of a well position (e.g., using Cartesian coordinates) that intersect the specified layer. The data processing system is configured to output data specifying facies clusters for the wells. In some implementations, the data output can include a vector or set of vectors that specify well identifiers for each cluster. In addition, the data processing system uses similarity measures such as correlation coefficient to validate the result of clustering. For example, the data processing system can determine whether the identified wells are within a threshold similarity based on the correlation coefficient values.

A third approach can include a combination of both the first and the second approaches, previously described. The data processing system, for performing this process, is configured to receive data specifying the key wells that are identified by the first approach as previously described. The data processing system applies a threshold based on a Euclidian distance to generate one or more initial sets of wells for each facies cluster. The third approach permits to compare the results found by both the first and the second approaches and to choose the result that fits best the conceptual model of the geologist. Even though the first step usually gives accurate results, sometimes it is still challenging to identify the correct facies clusters due to complex lithologies in a subterranean formation. Thus, the data processing system may perform additional operations (such as steps 2 and 3) to overcome this challenge.

Process 200 includes determining (204), by the data processing system, neighboring wells for each facies cluster. For example, the data processing system can be configured for finding a proper neighbors. The data processing system may represent the wells as interconnected points in a network based on their geographical locations. A proper neighbor of a well refers to any other well that is connected to the well in that network with an edge determined by triangulation algorithm. In some implementations, the data processing system performs a triangulation algorithm to identify the proper neighbors of the samples. Using triangulation algorithm to obtain the sample neighbors, the data processing system may check if the neighbors are on the same cluster or not. The selected sample will be the centroid of the polygon with respect to its neighbors. When identifying neighbors in different clusters, the data processing system initiates a third step, which is sample correction. Both, the triangulation algorithm and the correct sample selection to be updated will permit to identify accurately the boundaries between the different rock types.

Process 200 includes updating (206) each facies cluster based on scoring each well for each facies cluster. For example, the data processing system can perform sample correction, which includes computing the silhouette score for the samples at the boundary to identify to which cluster those samples belong. The data processing system can update the boundary of each facies cluster through each layer of the subsurface based on reassignment of the values, which occurs based on the silhouette scores. Also sample correction presents the data in a way that preserves all needed geological information for appropriate interpretation.

The data processing system performs sample correction, as previously described. The data processing system, based on sample correction, is able to reassign samples to a facies cluster with a highest silhouette score relative to other facies clusters to maximize each sample silhouette scores. This gives the best cluster shape and size with a significant accuracy. The data processing system can calculate the sample silhouette score with respect to all the adjacent clusters. The data processing system selects the cluster with the highest similarities, allowing to correct the sample cluster and improve the quality of all the clusters.

The sample correction of the data processing system enables the data processing system to accurately classify wells into respective facies clusters. For example, when layers include different rock types within the same layer, the layer can cause there to appear to be different signatures in different wells. The data processing system is able to accurate classify the wells despite this by performing sample correction.

The sample correction of the data processing system also results in a very reliable and robust facies cluster across each subsurface layer and gives a better representation of it. The determined facies clusters provide information about the propagation of the different facies or rock types within any subsurface layer with or without core data by drawing its geometry in 3D which allows the data processing system to interpret the different wells with a geological mindset.

Process 200 includes assigning (210) a new well to a facies cluster based on a supervised artificial intelligence (AI) model. The data processing system can execute an artificial neural network (ANN) on the data logs associated with new wells to determine the encountered facies and assign a given well to a correct facies cluster. The clustering of the new well is done after training on the result obtained from previous steps. This would guarantee a reliable and continuous update for our geological models.

The data processing system generates a reliable model for each subsurface layer while preserving all needed geological information. The data processing system is able to assign wells to facies clusters based on constraints of each of the spatial relationship and a determined facies signature (e.g., of each facies) simultaneously. The data processing system can define the rock types and their boundaries to preserve the appropriate geometry of each facies.

FIG. 2B illustrates an example workflow 250 for determining subterranean properties of a reservoir. Each of the workflows described in this specification, including workflow 250 of FIG. 2B, can be implemented or executed using the computer system 124 as well as the workbench, computing device, and/or machine-learning engine described in this document. Descriptions of the different workflows in this document may reference the computer system 124, including other computational resources associated with computer system 124 as described in this document. In general, references to “the system(s)” corresponds to the computer system 124.

In some implementations, steps or actions of the different workflows are enabled by programmed firmware or software instructions, which are executable by one or more processors of the devices and resources described in this document. An example workflow may be referred to alternatively as a process or method of performing a particular set of tasks for determining subterranean properties of a reservoir.

At step 252, the data processing system receives log data for a plurality of wells in the reservoir. The log data represent at least one petrophysical property of a subsurface of the reservoir for the plurality of wells. The log data may include multiple petrophysical properties generated by various logging techniques and sensors. For example, nuclear magnetic resonance (NMR) logging measures the induced magnetic moment of hydrogen nuclei (i.e., protons) contained within the fluid-filled pore space of porous media (e.g., reservoir rocks). For determining permeability, spontaneous potential (SP) logging may be used to determine the permeabilities of rocks in the formation by measuring the amount of electrical current generated between drilling fluid produced by the drilling system and formation water that is held in pore spaces of the reservoir rock. The logging sensors may include acoustic sensors (e.g., accelerometers and hydrophones), transmitters and receivers to measure resistivity, gamma ray (GR) detectors, etc.

In some implementations, the log data for the plurality of wells is the initial data, and the system may process the log data directly.

In some implementations, the system may first receive log data for an initial set of wells in the reservoir. The initial set of wells include the plurality of wells and some other wells. The other wells' logs may not be normal or expected due to some logging equipment malfunction or technical problems during the logging process. The log data for such wells should be labeled as outliers or anomalies and removed from the dataset, which is called anomaly detection.

The data processing system may use different approaches for anomaly detection. The geologists may manually inspect the log data, identify wells with problematic log data, and remove the log data for the identified wells. Alternatively, automatic outlier detection methods such as an isolation forest outlier method and a local outlier factor method may be used. The isolation forest outlier method is a tree-based anomaly detection algorithm, which uses an unsupervised learning approach and focus on characterizing outliers instead of normal data points. The local outlier factor method is an unsupervised anomaly detection method, which computes a local density deviation of a given data point with respect to its neighbors.

At step 254, the data processing system generates multiple facies clusters based on the log data for the plurality of wells in the reservoir. Each facies cluster represents a set of wells of the plurality of wells that are associated with similar values for the at least one petrophysical property of the subsurface. In other words, the plurality of wells is partitioned or classified into multiple facies clusters. Each facies cluster includes a set of wells whose log data reveal a similar pattern. The multiple facies clusters may be mutually exclusive. At this step, the system may also determine a key well for each facies cluster, which refers to the best representative well in that facies cluster. The system may use various clustering algorithms and key well identification methods in this step.

In some implementations, the system uses a machine learning based clustering approach to determine the multiple facies clusters and then identifies multiple key wells based on each determined facies cluster. One example of the machine learning based clustering approach is a k-means clustering algorithm, which includes a standard k-means algorithm and its variations. The standard k-means clustering algorithm (or standard k-means algorithm) partitions input data samples into k clusters by minimizing a sum-squared-error criterion, which is a sum of squared Euclidean distances between each data sample and a mean (also referred to as a centroid) of the cluster that data sample is assigned to or belongs to.

A similarity score can be used to measure or evaluate the quality of the clustering result. A good clustering result usually has clusters well apart from each other and clearly distinguished. The similarity score can also be used to determine an appropriate number of clusters (i.e., k) for the k-means clustering algorithm and make the algorithm converges quickly. One example of the similarity score is silhouette score. A silhouette score is an average of silhouette coefficients for each data sample. The silhouette coefficient for a data sample is calculated based on an average intra-cluster distance (distances between the data sample and other data samples in the cluster the data sample is assigned to) and an average nearest-cluster distance (distances between the data sample and all data samples in the nearest neighbor cluster).

In some implementations, the system may use the standard k-means algorithm to cluster the plurality of wells to generate multiple facies clusters. The system may use the silhouette score as a stopping criterion to determine the number of the multiple facies clusters. Then for each facies cluster, a key well is selected from the set of wells in that facies cluster. For example, the at least one petrophysical property may include a GR signature. In other words, the log data for each of the plurality of wells include GR signatures. In this case, the system can compute an average GR signature of a facies cluster and compare the average GR signature with the GR signatures for each well in the facies cluster. The well whose GR signature is closest to the average one is identified as the key well for that facies cluster.

In some implementations, the system may use an interactive approach based on core data analysis performed by the geologists to determine the key wells and facies clusters. Coring operations include physically extracting a rock sample from a region of interest within the well for detailed laboratory analysis. For example, when drilling a well, a coring bit may cut plugs (or cores) from the formation and bring the plugs to the surface, and these core samples may be analyzed at the surface by the geologists to determine various characteristics of the formation. If the geologists have enough core data from different wells in a reservoir, they may determine the number of facies clusters in the reservoir and select a key well for each facies cluster based on the core data. The system then determines a set of wells in each facies cluster based on the geographic locations of the key wells and the remaining wells. For example, for each of the remaining wells, the system may find the closest key well and assign the well to the facies cluster the closest key well belongs to. Furthermore, the system may use a similarity score to validate the facies clustering result.

In some implementations, the system may use a combination of the facies clustering and the key well identification methods that are described above. For example, the system determines the key wells using the standard k-means algorithm and the GR signature based key well identification. Then for each of the remaining wells, the system may find the closest key well and assign the well to the facies cluster the closest key well belongs to. Such a combination permits the system to compare the results found by different approaches and to choose the facies clustering and key well identification result that fit the conceptual model of the geologists.

At step 256, the system determines one or more neighbor wells (or neighbors) for each of the plurality of wells. Each neighbor is selected from the plurality of wells and is determined based on geographic locations of the plurality of wells. In some implementations, the system may use a triangulation algorithm to identify proper neighbors for each well, such that the well will be at the centroid of a polygon with respect to its neighbors. The system uses the triangulation algorithm to associate the multiple facies clusters with one another and calculate the distances that separate them. The system may then determine a score according to the triangulated distance from the closest edge and from the centroid of the polygon.

A purpose of determining the neighbor wells is to identify boundaries between different facies clusters. The initial facies clustering result for wells on the boundaries may not be accurate. Thus, the system may update the facies clusters that represent the wells on the boundaries to improve the quality of the facies clusters.

At step 258, the system may update a facies cluster that represents a well. For each of the plurality of wells, the system first determines whether the well is on a facies cluster boundary or within a threshold distance of a facies cluster boundary. The system determines that the well is on the facies cluster boundary (also referred to as “boundary”) upon determining that the well and its neighbor are represented by different facies clusters. The system does not re-assign a facies cluster for a well if the well is not on a facies cluster boundary. In other words, the facies cluster that represents a well is considered as valid if the well and its neighbor wells belong to the same facies cluster (i.e., the well and its neighbors are located within a triangle based on the triangulation algorithm).

In some implementations, the system calculates silhouette scores for each well with respect to all neighboring clusters. The system may determine that a well is on the boundary if the well has negative silhouette scores which are less than a threshold.

In some implementations, the system may determine that a well is on the boundary if the well has low silhouette scores with a key well that belongs to the same facies cluster as the well.

Step 258 includes two sub-steps 260 and 262. At step 260, the system determines a similarity score between the well and each facies cluster. To update or correct a facies cluster for a well on a boundary, the system determines a similarity score between the well and each facies cluster. The similarity score represents a similarity between the at least one petrophysical property for the well and the at least one petrophysical property for the set of wells represented by each facies cluster. In some implementations, the silhouette score may be used as the similarity score. At step 262, the system updates the facies cluster representing the well, the updated facies cluster having the largest similarity score. Among the multiple facies clusters, the system selects a facies cluster that has the largest similarity score with the well on the boundary as an updated facies cluster and reassign the updated facies cluster to the well.

At step 264, the system determines the subterranean properties of the reservoir based on the multiple facies clusters and the set of wells represented by each facies cluster.

In some implementations, the system may use Entropy algorithms to measure the quality of the updated facies clusters. Then the system may combine some clusters together to improve the quality. The system may perform an interactive editing step that allows someone to have a better representation of the subsurface.

The system may assign a facies cluster to a new well based on a supervised artificial intelligence (AI) model. The system may first train and validate the supervised AI model using the log data and the clustered result obtained during the previous steps, which include the multiple facies clusters and the geographic locations of the plurality of wells. Then the system may determine a facies cluster for the new well using the supervised AI model based on the geographic location of the new well and the log data of the new well.

In some implementations, the supervised AI model is an artificial neutral network (ANN).

In some implementations, the facies cluster for the new well and the log data of the new well can also be used to train and update the supervised AI model. With the continuous updates, the system may obtain more log data from newly drilled wells and more clustering results, and the supervised AI model may get more reliable due to the new training data.

In some implementations, the workflow 250 further includes: identifying a target layer representing a presence of hydrocarbons based on the determined subterranean properties of the reservoir and drilling a well to the target layer.

In some implementations, the workflow 250 further includes: selecting a new geographic location in the reservoir for drilling a new well, receiving log data for the new well, and assigning one of the multiple facies clusters to the new well based on the new geographic location and the log data of the new well.

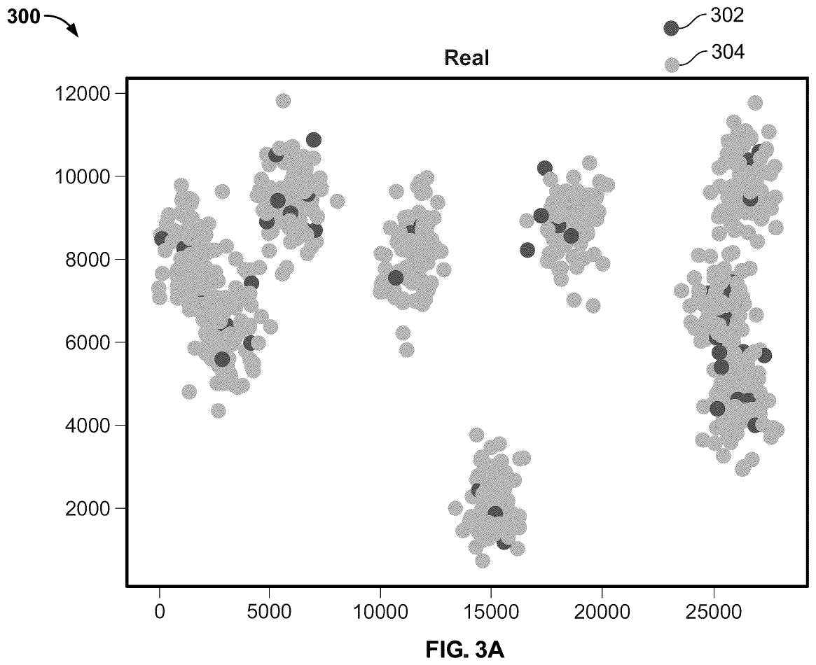

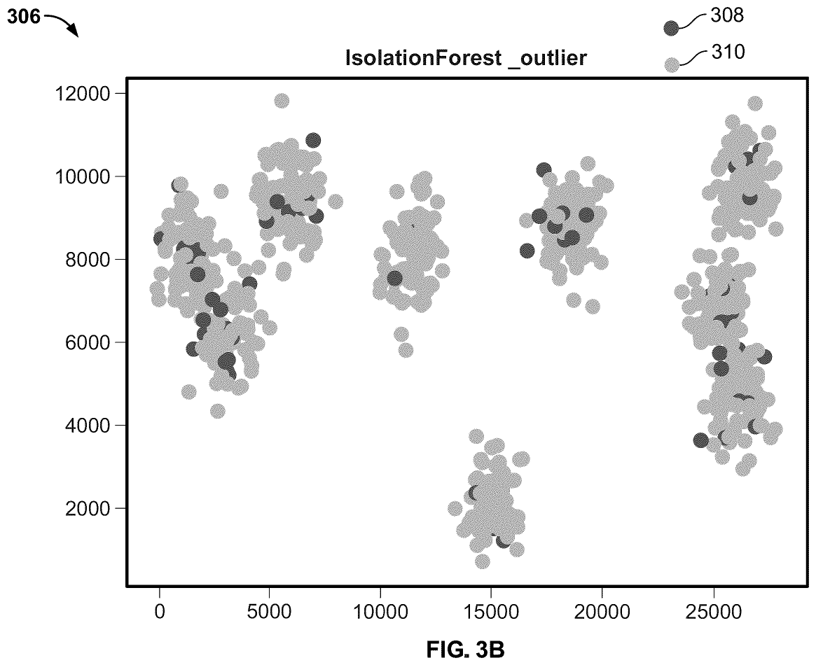

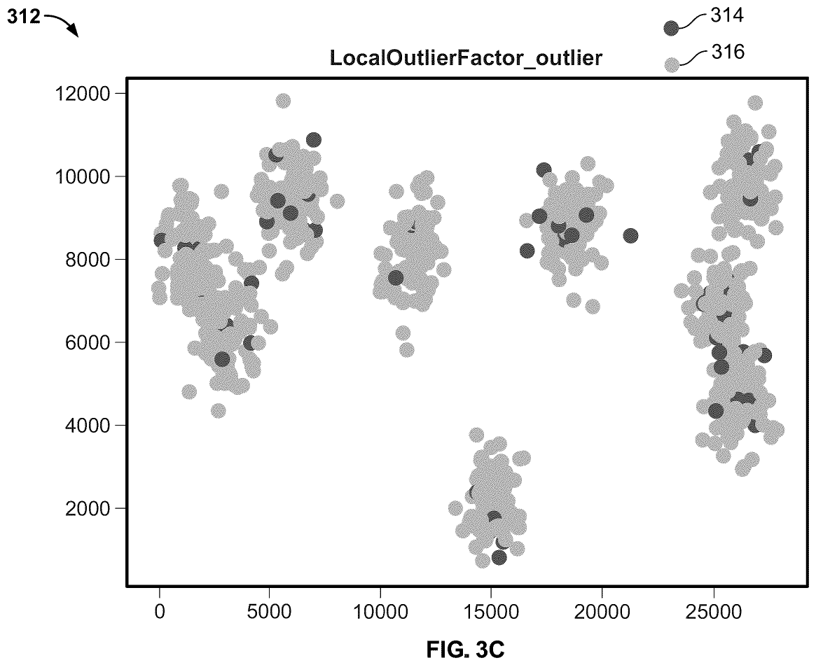

FIGS. 3A-3C each include a graph that illustrates an example anomaly detection method. FIG. 3A shows graph 300 of an initial set of 900 wells including wells 304 with normal log data and outlier wells 302 with abnormal log data. The x axis and y axis represent geographical coordinates of a well. The outlier wells 302 are identified by the geologists manually. FIG. 3B shows graph 306 including the same initial set of wells with outlier wells 308 detected by the Isolation Forest Outlier method. Wells 310 are classified by the Isolation Forest Outlier method as wells that have normal log data. FIG. 3C shows graph 312 of the same initial set of wells with outlier wells 314 detected by the

Local Outlier Factor method. Wells 316 are classified by the Local Outlier Factor method as wells that have normal log data. Detailed analysis shows that the Isolation Forest Outlier provides less matches with the geologists' manual work, while the Local Outlier Factor method, which identifies 72 outlier wells, has cleaned the original log data more properly and showed more matches with the geologists' manual work. Although FIGS. 3A-3C illustrate some exemplary anomaly detection methods, these examples are not intended to be construed in a limiting sense. Any suitable anomaly detection methods known in the art may be used in the anomaly detection for determining subterranean properties of the reservoir.

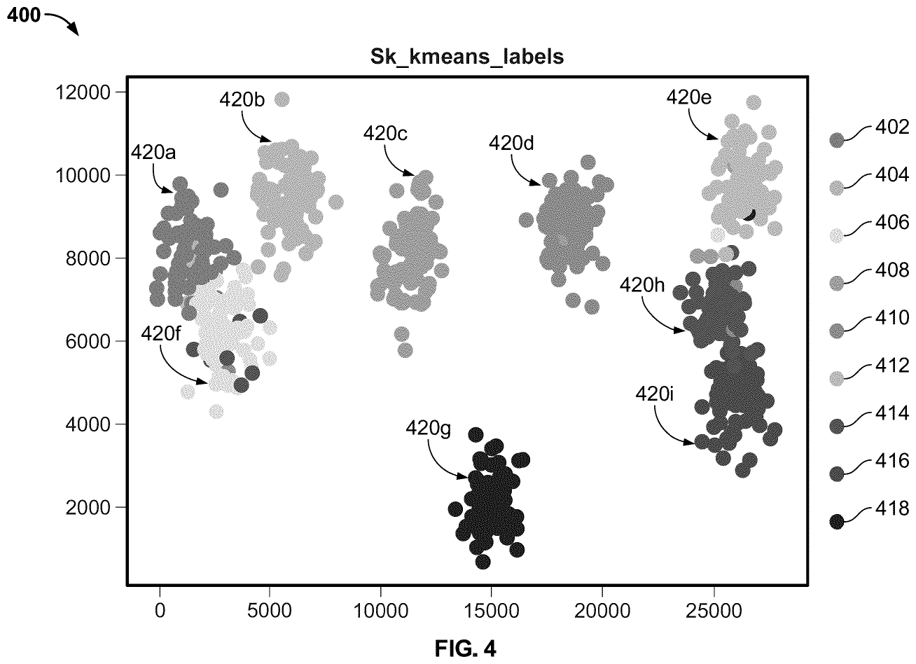

FIG. 4 includes a graph 400 that illustrates example labeled facies clusters. This example uses the same log data for 828 wells of FIG. 3C (after removing the 72 outlier wells from the initial 900 wells). The system employs the standard k-means algorithm and uses the silhouette score as a stopping criterion. The system uses Euclidean distance metric to calculate the distance between averages of all data points and assign the unlabeled points to their appropriate facies cluster. The standard k-means algorithm starts with random location of centroid associated with some similarity measures such as Silhouette score, Calinski Harabasz score, and Davies Bouldin score to improve the quality of each facies cluster. As a result, the system has successfully grouped rock types into 9 facies clusters 420a, 420b, 420c, 420d, 420e, 420f, 420g, 420h, and 420i. Each facies cluster represents a set of wells. For example, facies cluster 420a represents well 402, facies cluster 420b represents well 404, facies cluster 420c represents well 406, facies cluster 420d represents well 408, facies cluster 420e represents well 410, facies cluster 420f represents well 412, facies cluster 420g represents well 414, facies cluster 420h represents well 416, and facies cluster 420i represents well 418. The clustering result matches the manual clustering work performed by the geologists who also discovered 9 facies clusters.

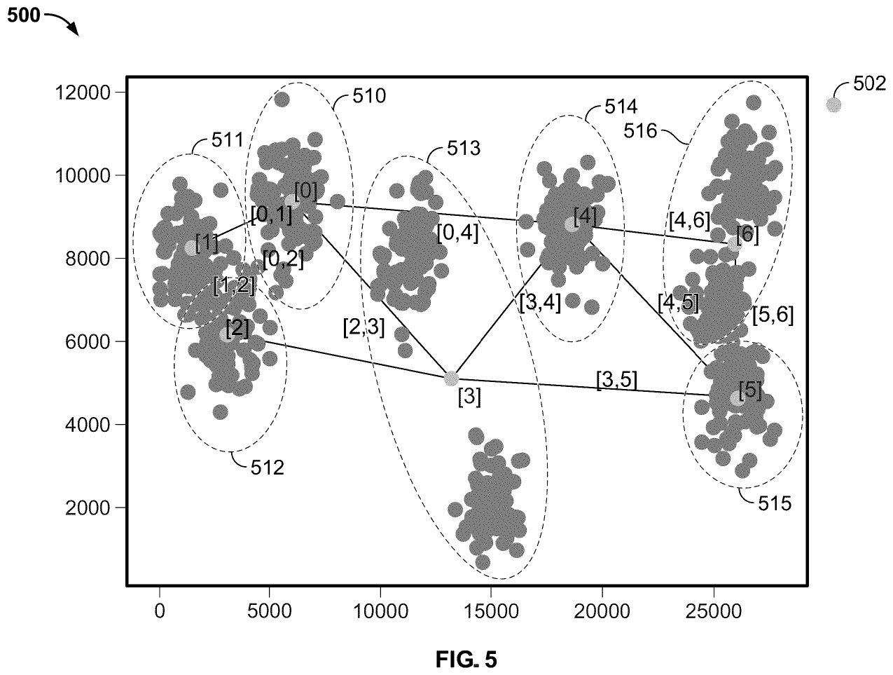

FIG. 5 includes a graph 500 that represents the relationship between the different clusters and how similar they are. First, a centroid (dots 502) and average signature are obtained for each cluster of clusters 510-516 as shown in FIG. 5. The centroid wells that represent each cluster are linked together with an edge (straight lines between each pair of clusters) using the triangulation algorithm. Euclidean distance is calculated between each two centroids and put in the edge to measure the similarity between the clusters (numbers associated with the edges). Thus, a smaller number will indicate more similar clusters and a larger number will indicate more different clusters. Users will have the option now to join clusters based on these numbers. The objective is to minimize the number of the distinct clusters.

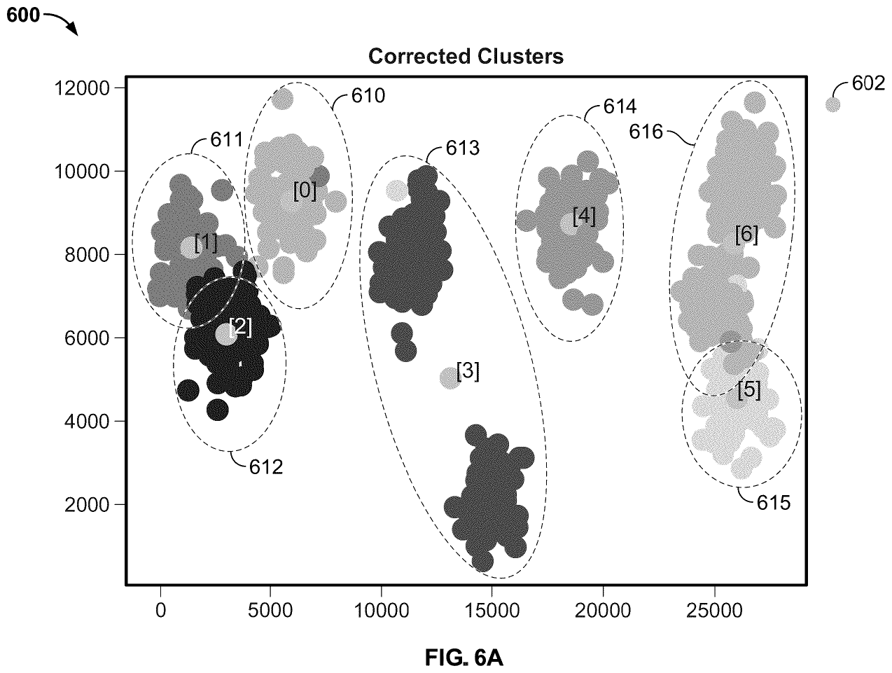

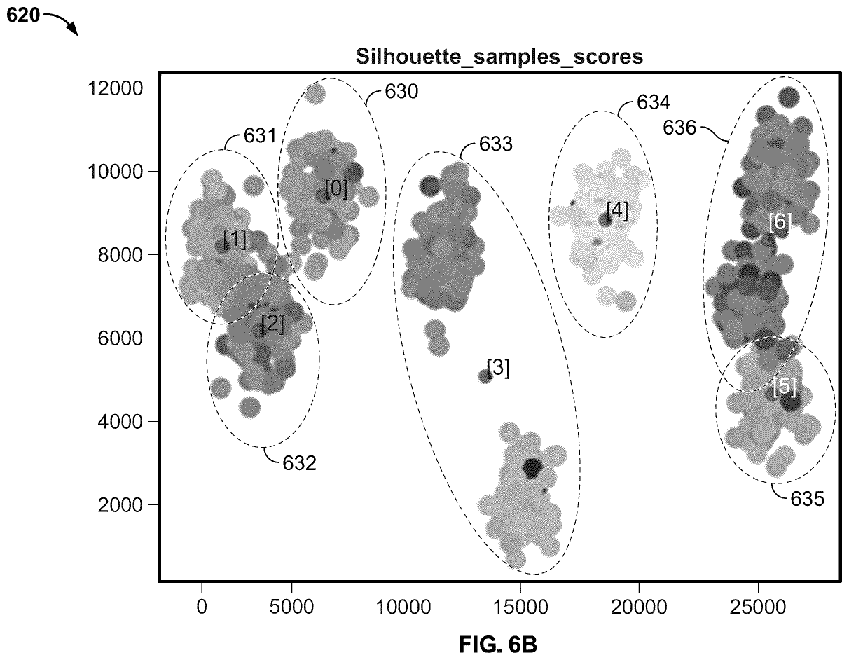

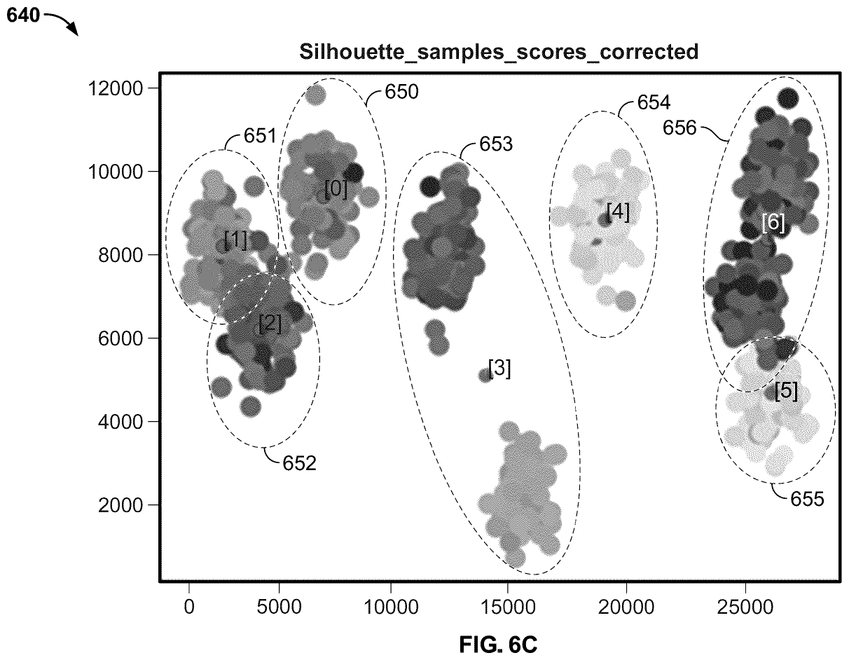

FIG. 6A includes a graph 600 showing that silhouette score is used in the final iteration after sample correction. As the algorithms update the wells along the boundaries, the silhouette score will be maximized. Thus, in the final iteration, the maximum silhouette score will be obtained. The dots 602 in FIG. 6A represents the centroids. FIG. 6A shows a successful clustering process that combines the facies into seven clusters 610-616. The seven clusters 610-616 are obtained from the previous algorithm in FIG. 5 to join multiple clusters based on Euclidean distance.

FIG. 6B includes a graph 620 showing updated facies clusters 630-636 based on the silhouette score. The different shapes for the clusters represent different silhouette scores.

FIG. 6C includes a graph 640 showing updated facies clusters 650-656 based on the maximum silhouette score.

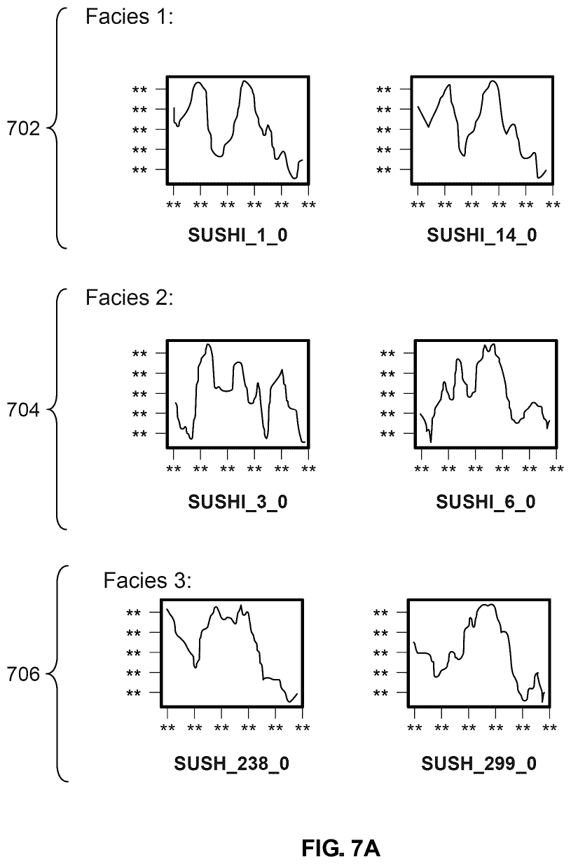

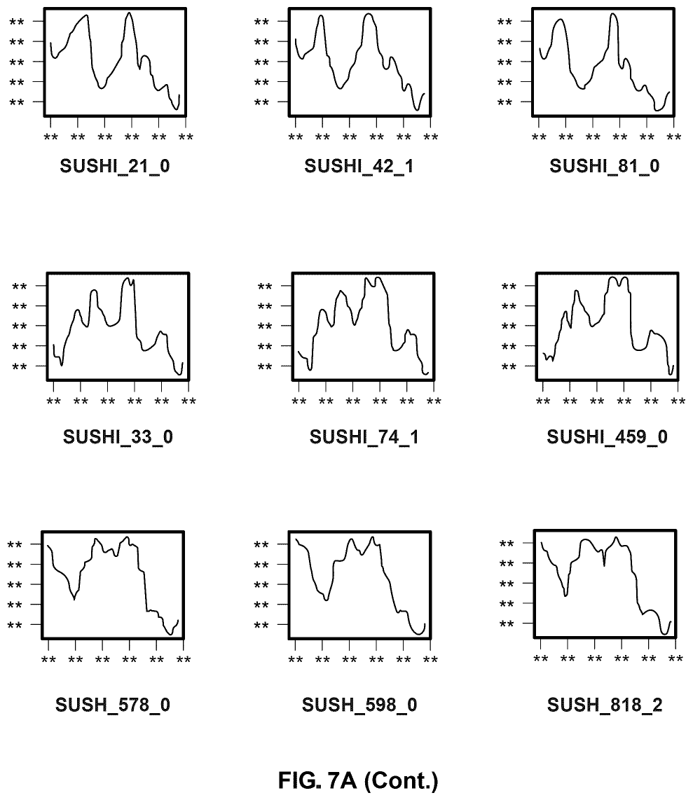

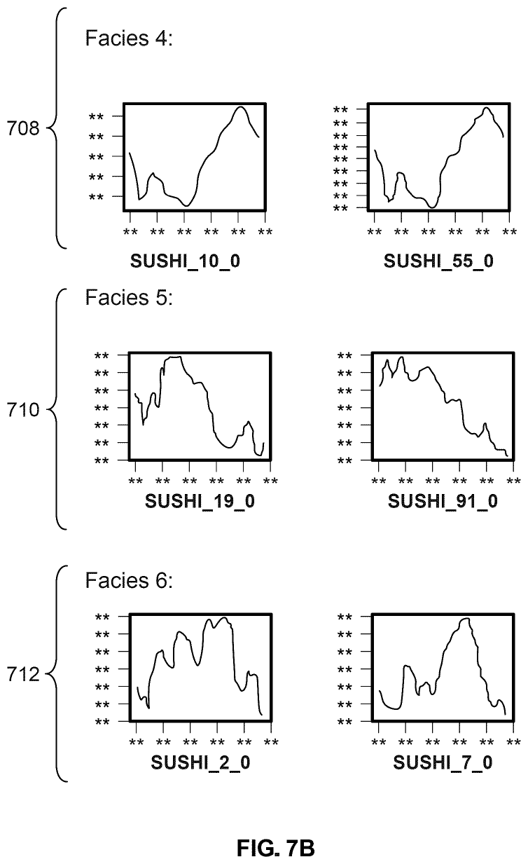

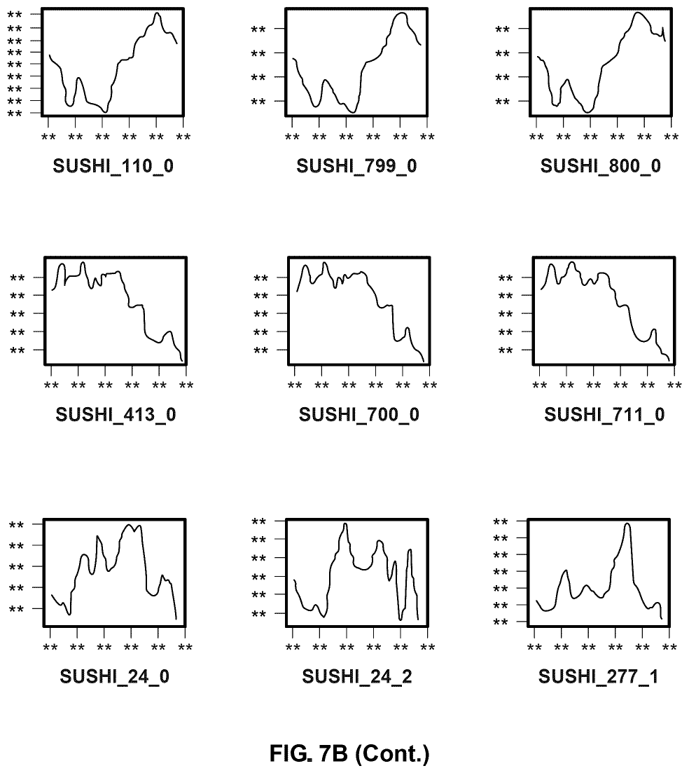

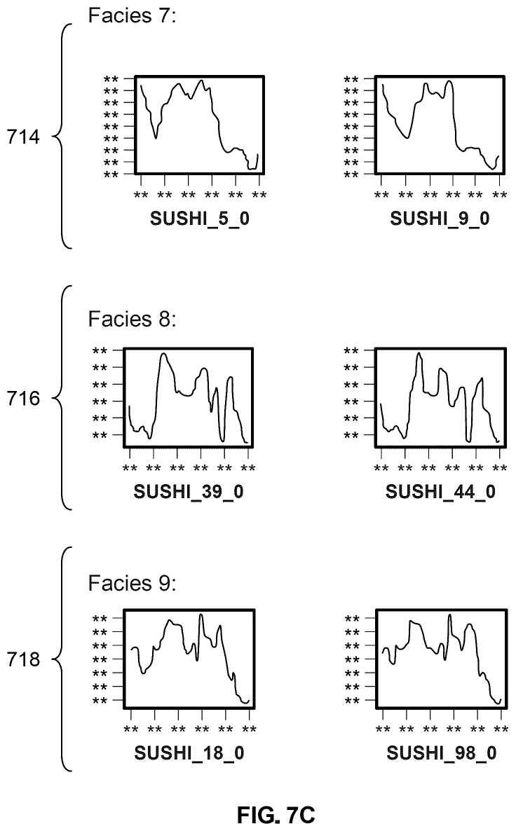

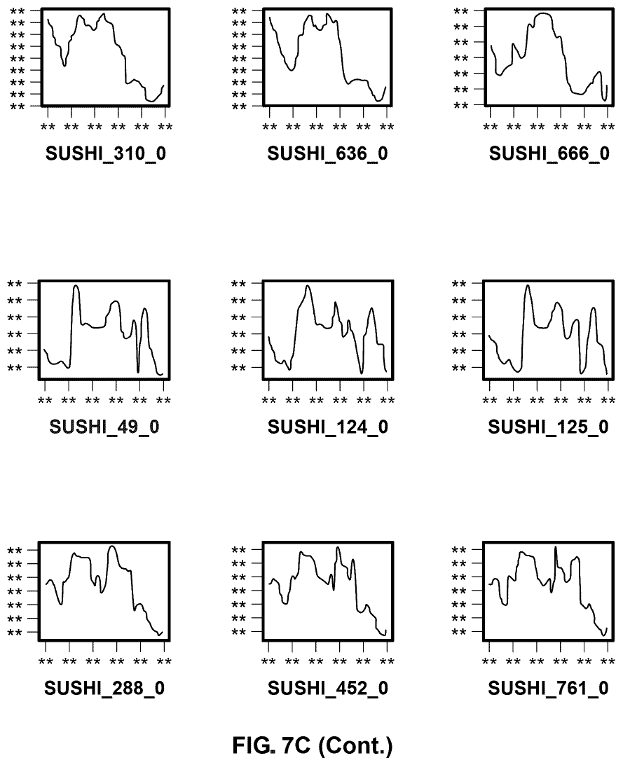

FIGS. 7A-7C include example well log patterns in each facies cluster. This practice maintains facies or rock types of each subsurface layer group in a list of wells which can eventually be utilized to build facies models and support the validation of field development plans. It has, also, proven its efficiency as it permitted to interpret the hidden patterns discovered to maximize recovery. Pattern 702 in FIG. 7A includes sample Gamma Ray well logs from 5 wells in facies cluster 1 (facies cluster 420a in FIG. 4) that have high scores in the similarity measure. The silhouette ranges between 1 to −1 where a values closer to 1 indicates well matched data to its own cluster and poorly match to neighboring clusters of the gamma ray values.

Pattern 704 in FIG. 7A includes sample well logs from 5 wells in facies cluster 2 (facies cluster 420b in FIG. 4) that have high scores in the similarity measure. Pattern 706 in FIG. 7A includes sample well logs from 5 wells in facies cluster 3 (facies cluster 420c in FIG. 4) that have high scores in the similarity measure. Pattern 708 in FIG. 7B includes sample well logs from 5 wells in facies cluster 4 (facies cluster 420d in FIG. 4) that have high scores in the similarity measure. Pattern 710 in FIG. 7B includes sample well logs from 5 wells in facies cluster 5 (facies cluster 420e in FIG. 4) that have high scores in the similarity measure. Pattern 712 in FIG. 7B includes sample well logs from 5 wells in facies cluster 6 (facies cluster 420f in FIG. 4) that have high scores in the similarity measure. Pattern 714 in FIG. 7C includes sample well logs from 5 wells in facies cluster 7 (facies cluster 420g in FIG. 4) that have high scores in the similarity measure. Pattern 716 in FIG. 7C includes sample well logs from 5 wells in facies cluster 8 (facies cluster 420h in FIG. 4) that have high scores in the similarity measure. Pattern 718 in FIG. 7C includes sample well logs from 5 wells in facies cluster 9 (facies cluster 420i in FIG. 4) that have high scores in the similarity measure.

FIG. 8 is a block diagram of an example computer system 800 used to provide computational functionalities associated with described algorithms, methods, functions, processes, flows, and procedures described in the present disclosure, according to some implementations of the present disclosure. The illustrated computer 802 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 802 can include input devices such as keypads, keyboards, and touch screens that can accept user information. Also, the computer 802 can include output devices that can convey information associated with the operation of the computer 802. The information can include digital data, visual data, audio information, or a combination of information. The information can be presented in a graphical user interface (UI) (or GUI).

The computer 802 can serve in a role as a client, a network component, a server, a database, a persistency, or components of a computer system for performing the subject matter described in the present disclosure. The illustrated computer 802 is communicably coupled with a network 830. In some implementations, one or more components of the computer 802 can be configured to operate within different environments, including cloud-computing-based environments, local environments, global environments, and combinations of environments.

At a high level, the computer 802 is an electronic computing device operable to receive, transmit, process, store, and manage data and information associated with the described subject matter. According to some implementations, the computer 802 can also include, or be communicably coupled with, an application server, an email server, a web server, a caching server, a streaming data server, or a combination of servers.

The computer 802 can receive requests over network 830 from a client application (for example, executing on another computer 802). The computer 802 can respond to the received requests by processing the received requests using software applications. Requests can also be sent to the computer 802 from internal users (for example, from a command console), external (or third) parties, automated applications, entities, individuals, systems, and computers.

Each of the components of the computer 802 can communicate using a system bus 803. In some implementations, any or all of the components of the computer 802, including hardware or software components, can interface with each other or the interface 804 (or a combination of both), over the system bus 803. Interfaces can use an application programming interface (API) 812, a service layer 813, or a combination of the API 812 and service layer 813. The API 812 can include specifications for routines, data structures, and object classes. The API 812 can be either computer-language independent or dependent. The API 812 can refer to a complete interface, a single function, or a set of APIs.

The service layer 813 can provide software services to the computer 802 and other components (whether illustrated or not) that are communicably coupled to the computer 802. The functionality of the computer 802 can be accessible for all service consumers using this service layer. Software services, such as those provided by the service layer 813, can provide reusable, defined functionalities through a defined interface. For example, the interface can be software written in JAVA, C++, or a language providing data in extensible markup language (XML) format. While illustrated as an integrated component of the computer 802, in alternative implementations, the API 812 or the service layer 813 can be stand-alone components in relation to other components of the computer 802 and other components communicably coupled to the computer 802. Moreover, any or all parts of the API 812 or the service layer 813 can be implemented as child or sub-modules of another software module, enterprise application, or hardware module without departing from the scope of the present disclosure.

The computer 802 includes an interface 804. Although illustrated as a single interface 804 in FIG. 8, two or more interfaces 804 can be used according to particular needs, desires, or particular implementations of the computer 802 and the described functionality. The interface 804 can be used by the computer 802 for communicating with other systems that are connected to the network 830 (whether illustrated or not) in a distributed environment. Generally, the interface 804 can include, or be implemented using, logic encoded in software or hardware (or a combination of software and hardware) operable to communicate with the network 830. More specifically, the interface 804 can include software supporting one or more communication protocols associated with communications. As such, the network 830 or the hardware of the interface can be operable to communicate physical signals within and outside of the illustrated computer 802.

The computer 802 includes a processor 805. Although illustrated as a single processor 805 in FIG. 8, two or more processors 805 can be used according to particular needs, desires, or particular implementations of the computer 802 and the described functionality. Generally, the processor 805 can execute instructions and can manipulate data to perform the operations of the computer 802, including operations using algorithms, methods, functions, processes, flows, and procedures as described in the present disclosure.

The computer 802 also includes a database 806 that can hold data (for example, log data 816) for the computer 802 and other components connected to the network 830 (whether illustrated or not). For example, database 806 can be an in-memory, conventional, or a database storing data consistent with the present disclosure. In some implementations, database 806 can be a combination of two or more different database types (for example, hybrid in-memory and conventional databases) according to particular needs, desires, or particular implementations of the computer 802 and the described functionality. Although illustrated as a single database 806 in FIG. 8, two or more databases (of the same, different, or combination of types) can be used according to particular needs, desires, or particular implementations of the computer 802 and the described functionality. While database 806 is illustrated as an internal component of the computer 802, in alternative implementations, database 806 can be external to the computer 802.

The computer 802 also includes a memory 807 that can hold data for the computer 802 or a combination of components connected to the network 830 (whether illustrated or not). Memory 807 can store any data consistent with the present disclosure. In some implementations, memory 807 can be a combination of two or more different types of memory (for example, a combination of semiconductor and magnetic storage) according to particular needs, desires, or particular implementations of the computer 802 and the described functionality. Although illustrated as a single memory 807 in FIG. 8, two or more memories 807 (of the same, different, or combination of types) can be used according to particular needs, desires, or particular implementations of the computer 802 and the described functionality. While memory 807 is illustrated as an internal component of the computer 802, in alternative implementations, memory 807 can be external to the computer 802.

The application 808 can be an algorithmic software engine providing functionality according to particular needs, desires, or particular implementations of the computer 802 and the described functionality. For example, application 808 can serve as one or more components, modules, or applications. Further, although illustrated as a single application 808, the application 808 can be implemented as multiple applications 808 on the computer 802. In addition, although illustrated as internal to the computer 802, in alternative implementations, the application 808 can be external to the computer 802.

The computer 802 can also include a power supply 814. The power supply 814 can include a rechargeable or non-rechargeable battery that can be configured to be either user-or non-user-replaceable. In some implementations, the power supply 814 can include power-conversion and management circuits, including recharging, standby, and power management functionalities. In some implementations, the power-supply 814 can include a power plug to allow the computer 802 to be plugged into a wall socket or a power source to, for example, power the computer 802 or recharge a rechargeable battery.

There can be any number of computers 802 associated with, or external to, a computer system containing computer 802, with each computer 802 communicating over network 830. Further, the terms “client,” “user,” and other appropriate terminology can be used interchangeably, as appropriate, without departing from the scope of the present disclosure. Moreover, the present disclosure contemplates that many users can use one computer 802 and one user can use multiple computers 802.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware-or software-based (or a combination of both hardware-and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

A number of embodiments of these systems and methods have been described. Nevertheless, it will be understood that various modifications may be made without departing from the spirit and scope of this disclosure. Accordingly, other embodiments are within the scope of the following claims.

What is claimed is:

1. A method for determining subterranean properties of a reservoir, the method comprising:
receiving log data for a plurality of wells in the reservoir, the log data representing at least one petrophysical property of a subsurface of the reservoir for the plurality of wells;
generating multiple facies clusters based on the log data, each facies cluster representing a set of wells of the plurality of wells that are associated with similar values for the at least one petrophysical property of the subsurface;
determining one or more neighbor wells for each of the plurality of wells based on geographic locations of the plurality of wells, the one or more neighbor wells being selected from the plurality of wells;
for each of the plurality of wells, determining that the well is within a threshold distance of a facies cluster boundary upon determining that the well and a neighbor well of the well are represented by different facies clusters;
for each well with the threshold distance of the facies cluster boundary:
determining a similarity score between the well and each facies cluster, the similarity score representing a similarity between the at least one petrophysical property for the well and the at least one petrophysical property for the set of wells represented by each facies cluster; and
updating the facies cluster representing the well, the updated facies cluster having the largest similarity score with the well among the multiple facies clusters; and
determining the subterranean properties of the reservoir based on the multiple facies clusters and the set of wells represented by each facies cluster.

2. The method of claim 1, further comprising:
identifying a target layer representing a presence of hydrocarbons based on the determined subterranean properties of the reservoir; and
drilling a well to the target layer.

3. The method of claim 1, further comprising:
selecting a new geographic location in the reservoir for drilling a new well;
receiving log data for the new well; and
assigning one of the multiple facies clusters to the new well based on the new geographic location and the log data of the new well.

4. The method of claim 1, wherein the plurality of wells in the reservoir is determined by removing outliers from an initial set of wells in the reservoir.

5. The method of claim 1, wherein the multiple facies clusters are generated by applying a standard k-mean clustering algorithm to the log data for the plurality of wells.

6. The method of claim 1, further comprising:
identifying a key well for each of the multiple facies clusters.

7. The method of claim 6, wherein the at least one petrophysical property comprises a gamma ray (GR) signature, and wherein for each of the multiple facies clusters, the key well for the facies cluster has the GR signature closest to an average of the GR signature of the set of wells represented by the facies cluster.

8. The method of claim 6, wherein for each of the multiple facies clusters, the key well for the facies cluster is determined by one or more geologists based on core data analysis.

9. The method of claim 6, wherein for each of the multiple facies clusters, the set of wells represented by the facies cluster are determined based on distances of the set of wells with respect to the key well.

10. The method of claim 1, wherein for each of the plurality of wells, the one or more neighbor wells of the well are determined by a Triangulation algorithm based on the geographic locations of the plurality of wells such that the well is a centroid of a polygon with respect to the one or more neighbor wells.

11. The method of claim 3, wherein the assigning one of the multiple facies clusters to the new well comprises:
training and validating a supervised artificial intelligence (AI) model using the geographic locations of the plurality of wells and the multiple facies clusters; and
determining a facies cluster for the new well using the supervised AI model based on the geographic location of the new well and the log data of the new well.

12. The method of claim 11, wherein the supervised AI model is an artificial neural network.

13. A system for determining subterranean properties of a reservoir, the system comprising one or more processing devices and one or more non-transitory machine-readable storage devices storing programming instructions for execution by the one or more processing devices to cause the system to perform operations comprising:
receiving log data for a plurality of wells in the reservoir, the log data representing at least one petrophysical property of a subsurface of the reservoir for the plurality of wells;
generating multiple facies clusters based on the log data, each facies cluster representing a set of wells of the plurality of wells that are associated with similar values for the at least one petrophysical property of the subsurface;
determining one or more neighbor wells for each of the plurality of wells based on geographic locations of the plurality of wells, the one or more neighbor wells being selected from the plurality of wells;
for each of the plurality of wells, determining that the well is on a facies cluster boundary upon determining that the well and a neighbor well of the well are represented by different facies clusters;
for each well on the facies cluster boundary:
determining a similarity score between the well and each facies cluster, the similarity score representing a similarity between the at least one petrophysical property for the well and the at least one petrophysical property for the set of wells represented by each facies cluster; and
updating the facies cluster representing the well, the updated facies cluster having the largest similarity score with the well among the multiple facies clusters; and
determining the subterranean properties of the reservoir based on the multiple facies clusters and the set of wells represented by each facies cluster.

14. The system of claim 13, wherein the multiple facies clusters are generated by applying a standard k-mean clustering algorithm to the log data for the plurality of wells.

15. The system of claim 13, wherein the operations further comprise:
identifying a key well for each of the multiple facies clusters.

16. The system of claim 15, wherein the at least one petrophysical property comprises a gamma ray (GR) signature, and wherein for each of the multiple facies clusters, the key well for the facies cluster has the GR signature closest to an average of the GR signature of the set of wells represented by the facies cluster.

17. The system of claim 13, wherein the operations further comprise:
training and validating a supervised artificial intelligence (AI) model using the geographic locations of the plurality of wells and the multiple facies clusters; and
determining a facies cluster for a new well using the supervised AI model based on a geographic location of the new well and the log data of the new well.

18. A non-transitory machine-readable storage device storing programming instructions for determining subterranean properties of a reservoir, wherein the programming instructions are for execution by at least one processing device to cause performance of operations comprising:
receiving log data for a plurality of wells in the reservoir, the log data representing at least one petrophysical property of a subsurface of the reservoir for the plurality of wells;
generating multiple facies clusters based on the log data, each facies cluster representing a set of wells of the plurality of wells that are associated with similar values for the at least one petrophysical property of the subsurface;
determining one or more neighbor wells for each of the plurality of wells based on geographic locations of the plurality of wells, the one or more neighbor wells being selected from the plurality of wells;
for each of the plurality of wells, determining that the well is on a facies cluster boundary upon determining that the well and a neighbor well of the well are represented by different facies clusters;
for each well on the facies cluster boundary:
determining a similarity score between the well and each facies cluster, the similarity score representing a similarity between the at least one petrophysical property for the well and the at least one petrophysical property for the set of wells represented by each facies cluster; and
updating the facies cluster representing the well, the updated facies cluster having the largest similarity score with the well among the multiple facies clusters; and
determining the subterranean properties of the reservoir based on the multiple facies clusters and the set of wells represented by each facies cluster.

19. The non-transitory machine-readable storage device of claim 18, wherein the multiple facies clusters are generated by applying a standard k-mean clustering algorithm to the log data for the plurality of wells.

20. The non-transitory machine-readable storage device of claim 18, wherein the operations further comprise:
training and validating a supervised artificial intelligence (AI) model using the geographic locations of the plurality of wells and the multiple facies clusters; and
determining a facies cluster for a new well using the supervised AI model based on a geographic location of the new well and the log data of the new well.
